(19) United States
(12) Patent Application Publication
(10) Pub. No.: US 2025/0117115 A1
(43) Pub. Date: Apr. 10, 2025

(54) METHOD, APPARATUS, TERMINAL AND STORAGE MEDIUM FOR INFORMATION PROCESSING

(71) Applicant: Beijing Zitiao Network Technology Co., Ltd., Beijing (CN)

(72) Inventors: Yuzhen Cai, Beijing (CN); Jiaming Li, Beijing (CN); Weipeng He, Beijing (CN); Kaixin Xiao, Beijing (CN)

(21) Appl. No.: 18/729,158

(22) PCT Filed: Jan. 12, 2023
(86) PCT No.: PCT/CN2023/071917

§ 371 Date: Jul. 15, 2024

(30) Foreign Application Priority Data
Jan. 18, 2022 (CN) 202210052803.6

(51) Int. Cl. G06F 3/0483; G06F 40/117; G06F 40/171

(52) U.S. Cl. CPC G06F 3/0483; G06F 40/117; G06F 40/171

(57) ABSTRACT

The disclosure provides a method, apparatus, terminal and storage medium for information processing. The method of information processing includes: in response to a first operation event on a first content in a content interface of a first document, creating first comment information of the first content in the content interface, and publishing the first comment information to a discussion interface, wherein the content interface and the discussion interface are different interfaces, and the discussion interface is configured to display information published by a current user and an associated user of the current user.

### CROSS REFERENCE

This application is filed based on a Chinese patent application with application Ser. No. 202210052803.6, filed on Jan. 18, 2022, entitled “METHOD, APPARATUS, TERMINAL AND STORAGE MEDIUM FOR INFORMATION PROCESSING”, and claims the benefit of the Chinese patent application, the entirety of which is incorporated herein by reference.

### FIELD

The present disclosure relates to a technical field of computer, and in particular, to a method, apparatus, terminal and storage medium for information processing.

### BACKGROUND

A content interface in a document is used to display content of the document. Users may comment on the content of the document while using the document, so that other users of the document can view the comments.

### SUMMARY

The present disclosure provides a method, apparatus, terminal and storage medium for information processing.

This disclosure employs the following technical solutions.

In some embodiments, the present disclosure provides a method of information processing, including:
in response to a first operation event on a first content in a content interface of a first document, creating first comment information of the first content in the content interface, and publishing the first comment information to a discussion interface;
wherein the content interface and the discussion interface are different interfaces, and the discussion interface is configured to display information published by a current user and an associated user of the current user.

In some embodiments, the present disclosure provides an apparatus for information processing, including:
a creating unit configured to, in response to a first operation event on a first content in a content interface of a first document, create first comment information of the first content in the content interface;
a publishing unit configured to publish the first comment information to a discussion interface;
wherein the content interface and the discussion interface are different interfaces, and the discussion interface is configured to display information published by a current user and an associated user of the current user.

In some embodiments, the present disclosure provides a terminal including: at least one memory and at least one processor;
the memory is used to store program code, the processor is used to call the program code stored in the memory to perform the above method.

In some embodiments, the present disclosure provides a computer readable storage medium for storing program code, which when executed by a processor causes the processor to perform the above method.

The method of information processing provided by the embodiments of the present disclosure can synchronize the created first comment information to the discussion interface when creating the first comment information for the first content displayed in the content interface of the first document, thereby extending the first comment information, enabling associated users of the current user to view the first comment information on the discussion interface without entering the first document achieving information diffusion and divergence, and enabling the associated users to timely understand the dynamics of the first comment information in the first document.

### BRIEF DESCRIPTION OF THE DRAWINGS

The above and other features, advantages and aspects of various embodiments of the present disclosure will become more apparent with reference to the following embodiments in conjunction with the accompanying drawings. Throughout the drawings, the same or similar reference numbers refer to the same or similar elements. It is to be understood that the drawings are schematic and that components and elements are not necessarily drawn to scale.

FIG. 1 is a schematic diagram of a display interface of the embodiments of the present disclosure.

FIG. 2 is a schematic diagram of a display interface of the embodiments of the present disclosure.

FIG. 3 is a schematic diagram of a display interface of the embodiments of the present disclosure.

FIG. 4 is a schematic diagram of a display interface of the embodiments of the present disclosure.

FIG. 5 is a schematic diagram of a display interface of the embodiments of the present disclosure.

FIG. 6 is a schematic diagram of a display interface of the embodiments of the present disclosure.

FIG. 7 is a schematic diagram of a record tree of the embodiments of the present disclosure.

FIG. 8 is a schematic diagram of version changes of the record tree of the embodiments of the present disclosure.

FIG. 9 is a schematic diagram of version changes of the record tree of the embodiments of the present disclosure.

FIG. 10 is a schematic structural diagram of an electronic device of the embodiments of the present disclosure.

### DETAILED DESCRIPTION

The embodiments of the present disclosure will be described in more detail below with reference to the accompanying drawings. Although certain embodiments of the disclosure are shown in the drawings, it should be understood that the present disclosure may be implemented in various forms and should not be construed as limited to the embodiments set forth herein, but rather these embodiments are provided for thoroughly and fully understand the present disclosure. It should be understood that the drawings and embodiments of the present disclosure are provided for illustrative purposes only but not intended to limit the scope of the present disclosure.

It should be understood that various steps described in the method implementations of the present disclosure may be executed in different orders and/or in parallel. Furthermore, the method implementations may include additional steps and/or the illustrated steps may be omitted. The scope of the present disclosure is not limited in this regard.

The term “including” and its variations as used herein are non-exclusive inclusion, i.e. “including but not limited to”. The term “based on” means “at least partially based on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that the concepts of “first” and “second” mentioned in this disclosure are only used to distinguish different apparatuses, modules, or units, but are not used to limit the order or interdependence of the functions performed by these apparatuses, modules, or units.

It should be noted that the modifications of “one” and “a plurality of” mentioned in this disclosure are illustrative but not limiting. Those skilled in the art should understand that unless otherwise indicated in the context, they should be understood as “one or more”.

The names of the messages or information interacted between a plurality of apparatuses in this public implementation are for illustrative purposes only, which are not intended to limit the scope of these messages or information.

The solution provided by embodiments of this application will be described in detail below with reference to the accompanying drawings.

In the process of using the document, comments may be made on the content of the document, and other collaborating users may reply under the comment. However, according to this method, the comment information is not diffused and extended, and other collaborating users can only reply to the comments within the document. In this case, the document has to be opened, resulting in low efficiency.

The information processing method according to the embodiments of the present disclosure includes: in response to a first operation event on first content in a content interface of a first document, creating first comment information of the first content in the content interface, and publishing the first comment information to a discussion interface.

In some embodiments of the present disclosure, the first document may be a local document or an online document, an interface where document content of the first document is located is a content interface, and the first content may be part or all of the document content in the first document. A user may add comment information to the first content, and the added comment information is the first comment information. The first comment information is associated with the first content. When the first comment information is created or after the first comment information is created, the first comment information is published to a discussion interface. The content interface and the discussion interface are different interfaces. The discussion interface may be an interface outside the first document. The discussion interface is configured to display information published by the current user and associated users of the current user, such as dynamic information published. The associated user may be a friend of the current user or a user in the same work group. The discussion interface can be a dynamic publishing interface. The information published by the current user in the discussion interface can be viewed by the associated user. In some embodiments of this disclosure, the first comment information created by the current user in the first document is synchronously transmitted to the discussion interface. Therefore, the spread and extension of the information is realized, so that other associated users can view the first comment information, and the associated users may directly view the first comment information in the discussion interface without entering the first document, and the associated users may reply to the first comment information in the discussion interface, thereby improving efficiency.

In some embodiments of the present disclosure, the first comment information in the content interface is kept in synchronization the first comment information in the discussion interface. In some embodiments, the specific content of the first comment information in the content interface is consistent with the specific content of the first comment information in the discussion interface. Operations performed on the first comment information in the content interface or discussion interface will take effect in both the content interface and the discussion interface. For example, if the first comment information in either the content interface or the discussion interface is modified, the first comment information in both the content interface and the discussion interface will be modified; if the first comment information is deleted from either the content interface or the discussion interface, the first comment information in both of the interfaces will be deleted. The first comment information in the content interface and discussion interface is kept in synchronization, and subsequent updates thereof are also kept in synchronized without having to perform operations on both sides.

In some embodiments of the present disclosure, associated information of the first comment information in the content interface is kept in synchronization with associated information of the first comment information in the discussion interface. In some embodiments, the associated information of the first comment information includes at least one of the following: reply information for the first comment information, like information for the first comment information, share information for the first comment information. In some embodiments, a reply may be made below the first comment information. Replies made in the content interface or discussion interface will be displayed in both the content interface and the discussion interface, so that users may reply to the first comment information in either the content interface or the discussion interface. In some embodiments, operations on the associated information in the content interface or discussion interface will take effect in both the content interface and the discussion interface. For example, reply information to a message will be displayed in both the content interface and the discussion interface. If the reply information is deleted from either the content interface or the discussion interface, the reply information in both the content interface and the discussion interface will be deleted.

In some embodiments of the present disclosure, the state of the first comment information in the content interface is kept in synchronization with the state of the first comment information in the discussion interface. In some embodiments, the state of the first comment information includes: hidden, not hidden, visible to some people, invisible to some people, etc. If the first comment information is set to be hidden in the content interface or discussion interface, the first comment information will not be displayed in either the content interface or the discussion interface. In some embodiments, if the first comment information in the content interface or discussion interface is invisible to some users, the first comment information in both the content interface and discussion interface will be invisible to the user, thereby avoiding information leakage.

In some embodiments of the present disclosure, in response to a triggering operation on a first control associated with the first comment information in the content interface, the first comment information in the discussion interface is jumped to. In some embodiments, the user may trigger the first control in the content interface of the first document, so as to jump to the discussion interface. The first comment information in the content interface can be displayed in a comment display interface. When creating the first comment information, a comment display interface associated with first content is created, the first comment information and its associated information are displayed in the comment display interface, and comment information for different contents is displayed in different comment display interfaces. The comment display interface may be an annotation interface, that is, the first comment information can be created for the first content by creating an annotation, and the first control may be a first-level control displayed in the comment display interface or a second-level control displayed in a function list. Since the first comment information is associated with the first control, the first comment information in the discussion interface can be jumped to from the content interface.

In some embodiments of the present disclosure, in response to a triggering operation on a second control associated with the first comment information in the discussion interface, the first comment information in the content interface is jumped to. In some embodiments, a second control is displayed in the discussion interface. The first comment information displayed in the content interface is jumped to through the second control. In this way, when users view the first comment information in the discussion interface, they can jump to the content interface thereby understands the first comment information with reference to the first content.

In some embodiments of the present disclosure, the first comment information in the content interface is displayed in a first predetermined format, the first comment information and at least one of the following are displayed in the first predetermined format: a publisher of the comment information, publication time of the comment information, a like identification of the comment information, the number of likes of the comment information, a reply identification of the comment information, the number of replies of the comment information, share identification of the comment information, the number of shares of the comment information, a reply area. In some embodiments, the first predetermined format can be a format of a topic post, the first comment information can be displayed in the form of a post, and the reply information of the first comment information may be a reply to the post, and it is displayed in the content interface in a form of a reply. In this way, the display of interactive content is more friendly, and a better user experience can be obtained.

In some embodiments of the present disclosure, the first comment information in the discussion interface is displayed in a second predetermined format, the first comment information and at least one of the following are displayed in the second predetermined format: a publisher of the comment information, publication time of the comment information, a like identification of the comment information, the number of likes of the comment information, a reply identification of the comment information, the number of replies of the comment information, a share identification of the comment information, the number of shares of the comment information, a reply area, quoted first content, an identification of the first document. In some embodiments, the second predetermined format may be a format of a topic post, and the second comment information may also be displayed in the form of a post, thereby improving the interactive experience.

In some embodiments of the present disclosure, an identification of the first document in the second predetermined format may be a second control, or it may be other controls. After the identification of the first document is triggered, one of the followings is performed: opening the first document; opening the first document and locating to the first content; opening the first document, locating to the first content and highlighting the first content. For example, after the identification of the first document is triggered, the first document can be opened and the first content can be highlighted for N seconds continuously, so that the user can quickly locate to the first content when there are a plurality of pieces of comment information, and then find the first comment information. In this way, when there are a plurality of pieces of comment information on a side the first content, although a plurality of pieces of comment information may be displayed at the same time, the user can determine the first comment information through the first content.

In some embodiments of the present disclosure, when the content interface of the first document is displayed in full screen, the content interface and the discussion interface are in different display interfaces. In some embodiments, the content interface of the first document can be displayed in full screen. At this time, the discussion interface is not in the currently displayed content interface, and it is displayed in other display interfaces. The discussion interface may be an interface outside the first document.

In some embodiments of the present disclosure, when the content interface of the first document is not displayed in full screen and the content interface of the first document is not displayed in full screen, the content interface and the discussion interface are in different tab pages, the tab pages are pages independent from each other. In some embodiments, when the content interface of the first document is not displayed in full screen, a plurality of tab pages can be displayed. The tab pages can be displayed in page cards. One page card corresponds to a tab page, and the content interface and content interface are displayed in different cards respectively. The discussion interface and the content interface are different interfaces, so as to avoid interference therebetween.

In some embodiments of the present disclosure, in response to the first operation event on the first content in the content interface of the first document, creating the first comment information of the first content in the content interface includes: in response to a first operation on the first content, displaying a comment publishing interface; and in response to a second operation, creating the first comment information of the first content based on information input to the comment publishing interface.

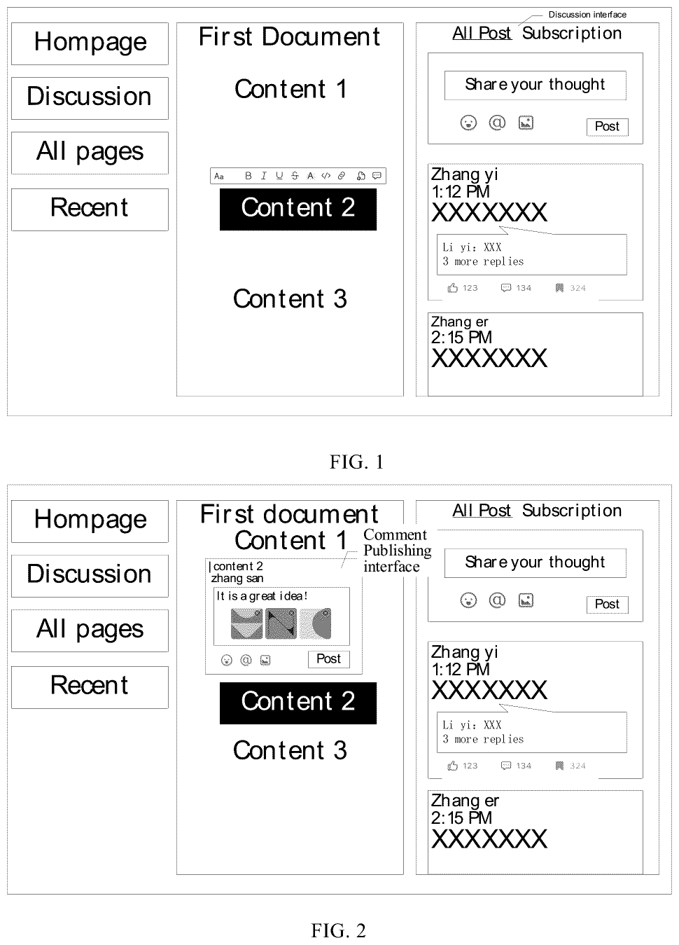

In some embodiments, please refer to FIG. 1 and FIG. 2. The first operation event may include one or more operations. For example, it may include a wording operation on the first content and a selection operation on the control list. As shown in FIG. 1, after the wording operation is performed on the first content (“Content 2” in FIG. 1), a control list is displayed. A plurality of controls are displayed in the control list, and a comment control in the control list is clicked, and then a comment publishing interface as shown in FIG. 2 is displayed. The first comment information is input to the comment publishing interface in the form of text, symbols, expressions, pictures, etc., and then the “Post” button on the comment publishing interface in FIG. 2 is clicked for publishing.

In some embodiments of the present disclosure, the comment publishing interface includes at least one of a quotation area, a text area and a picture area; the quotation area is configured to display part or all of the first content; the text area is configured to display text input to the comment publishing interface; and the picture area is configured to display pictures input to the comment publishing interface. In some embodiments, please refer to FIG. 2, there is a quotation area in the comment publishing interface in FIG. 2, in which a quoted “Content 2” is displayed to indicate that the comment information is a comment on “Content 2”. The text area is configured to input text, and the picture area is configured to insert pictures. The picture area is located below the text area, thus different types of information is separated to avoid confusion. Emoticons or @someone may also be inserted in the comment publishing interface. In some embodiments, as shown in FIG. 2, the comment publishing interface may provide a control for @someone.

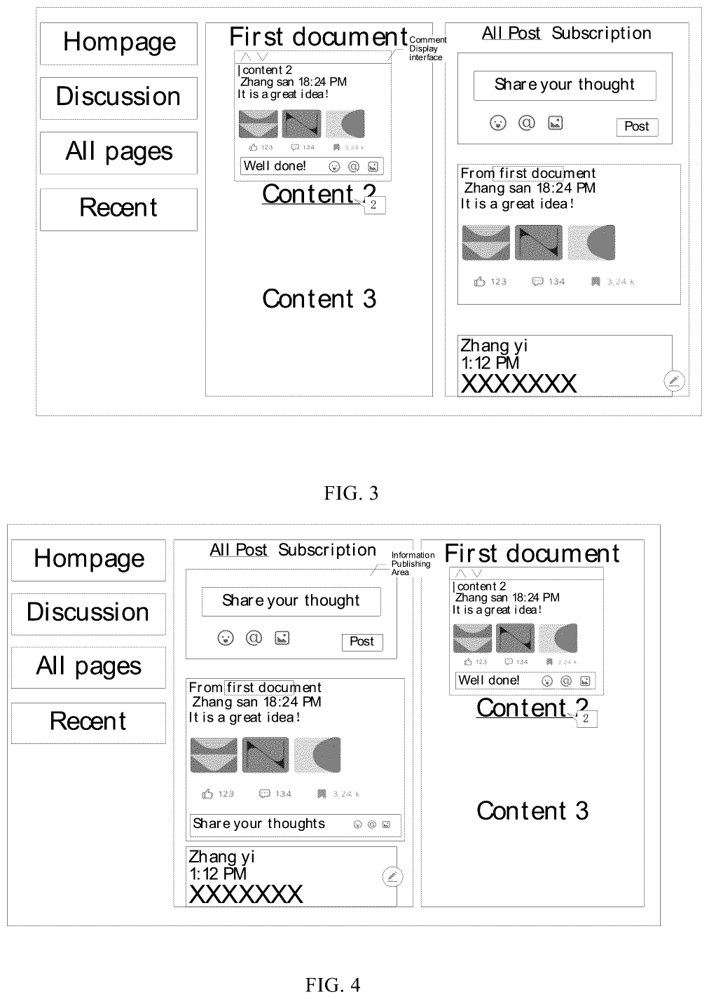

In some embodiments of the present disclosure, after the first comment information of the first content is created in the content interface, a first identification is displayed at an associated position of the first content. In some embodiments, please refer to FIG. 3. after the first comment information of the first content is created, the first comment information can be automatically hidden. At this time, in order to indicate that the first content has associated first comment information, a first identification is displayed next to the first content (comment box having number 2 therein in FIG. 3). In some embodiments, by clicking the first identification, the hidden first comment information and the reply information for the first comment information can be displayed. In some embodiments, the first comment information and the reply information are displayed in an annotation box, and only one comment information and all reply information of the comment information are displayed in one annotation box.

In some embodiments of the present disclosure, after the first comment information of the first content is created in the content interface, the first content is displayed in a first style, and the first style is different from a second style when the first content does not have associated comment information. In some embodiments, the color of the first content can be changed, or as shown in FIG. 3, an underline is displayed below the first content to indicate that the first content has associated first comment information. By changing the display style of the first content, it is indicated that the content has associated first comment information.

In some embodiments of the present disclosure, the method further includes: in response to a third operation on the first content, displaying a comment display interface on a side of the first content, and the first comment information being displayed on the comment display interface. In some embodiments, the first content can be triggered by clicking or other methods to display the first comment information. The comment display interface can be the annotation box of the first content.

In some embodiments, the content interface of the first document and the discussion interface are displayed in different display cards. Positions of the display cards may be changed. As shown in FIG. 3 and FIG. 4, the positions of the content interface and discussion interface can be exchanged by changing the positions of the display cards. The display cards can be closed and can be opened again through related controls after being closed.

In some embodiments of the present disclosure, when displaying the comment display interface, an input identification is focused on a reply area in the comment display interface. In some embodiments, as shown in FIG. 3, there is a reply area in the comment display interface. The reply area is used to enter reply information to the first comment information or a replay to the reply information. When the comment display interface is displayed, the input identification (such as the cursor) is automatically focused on the reply area (also called the input box), thereby reducing user operations and improving reply efficiency.

In some embodiments of the present disclosure, a third control is displayed on the comment display interface, and the first control is configured to switch the comment information displayed on the comment display interface after being triggered; and after switching, the comment information displayed on the comment display interface is the comment information in the first document. In some embodiments, please refer to FIG. 3, an up arrow and a down arrow is displayed as the third control in the comment display interface as shown in FIG. 3. By triggering the third control, the comment information that needs to be displayed can be switched in the comment display interface. For example, the previous or next comment information can be displayed. Therefore, the displayed comment information can be switched through the third control directly on the comment display interface, so that all comment information in the first document can be viewed without leaving the comment display interface.

In some embodiments of the present disclosure, a fourth control is displayed on a display interface, and the discussion interface is displayed after the fourth control is triggered. In some embodiments, please refer to FIG. 4, there are a plurality of controls displayed on the left side of FIG. 4. Both the content interface of the first document and discussion interface can be displayed in the display cards. The display cards may be closed, and after being closed, they may be opened through a control on the left side as shown in FIG. 4. For example, the “Discussion” control on the left side of FIG. 4 is configured to open the discussion interface after being triggered.

In some embodiments, as shown in FIG. 4, an information publishing area is displayed in the discussion interface. The information publishing area is configured to publish information. Users may directly publish information on the discussion interface. The published information may not be comment information; for example, it may be user updates, reflections, essays, etc. In some embodiments, the information publishing area may be located at the top of the discussion interface and may be fixed at the top. Even if the content of the discussion interface slides up or down, the information publishing area will always remain displayed at the top, instead of being hidden. In the information publishing area, text or pictures may be inserted or someone will be mentioned through @.

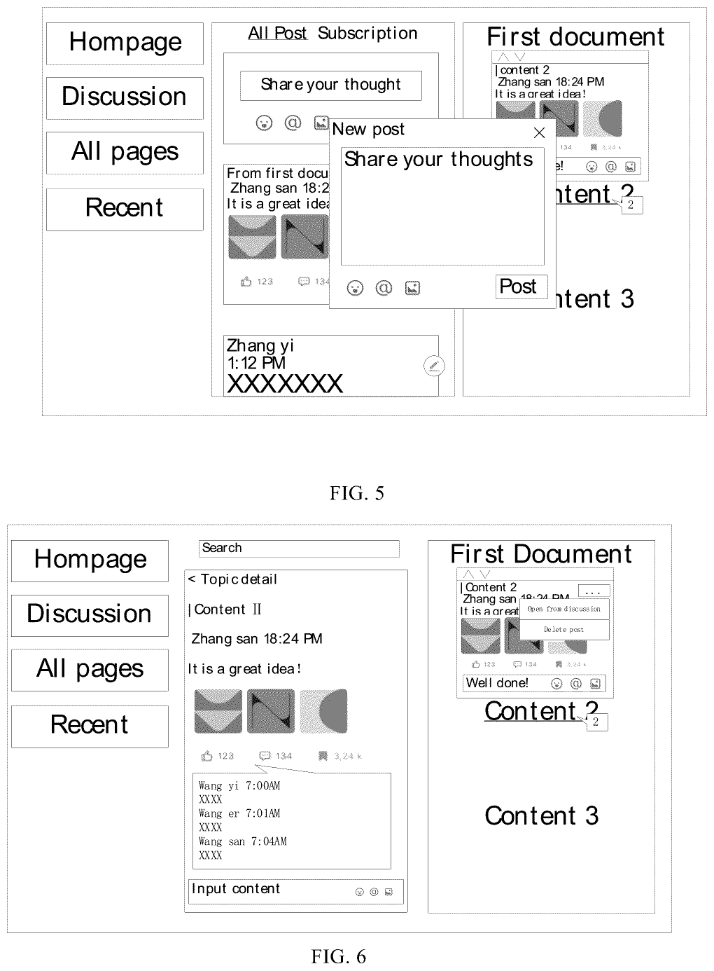

In some embodiments, a fifth control is displayed in the discussion interface, and the fifth control is configured to display an information publishing interface after being triggered, and the information publishing interface is configured to publish information on the discussion interface. In some embodiments, as shown in FIG. 4, the fifth control (pen symbol in the lower right corner of the middle of FIG. 4) is displayed in the discussion interface. After the fourth control is triggered, the information publishing interface as shown in FIG. 5 pops up, where text, Symbols, pictures, @someone and other information can be entered, and then be published in the discussion interface as information.

In some embodiments of the present disclosure, the discussion interface includes a first sub-interface and a second sub-interface, the first sub-interface is configured to display all information published on the discussion interface, and the second sub-interface is configured to display information associated with the current user in the discussion interface. In some embodiments, as shown in FIG. 4, a first sub-identification and a second sub-identification (“All Post” and “Subscription” in FIG. 4) can be displayed in the discussion interface. After the first sub-identification is triggered, the first sub-interface is displayed, and after the second sub-identification is triggered, the second sub-interface is displayed, so that the user may quickly view the information associated with himself through the second sub-interface. The information associated with the current user can be the information subscribed by the current user.

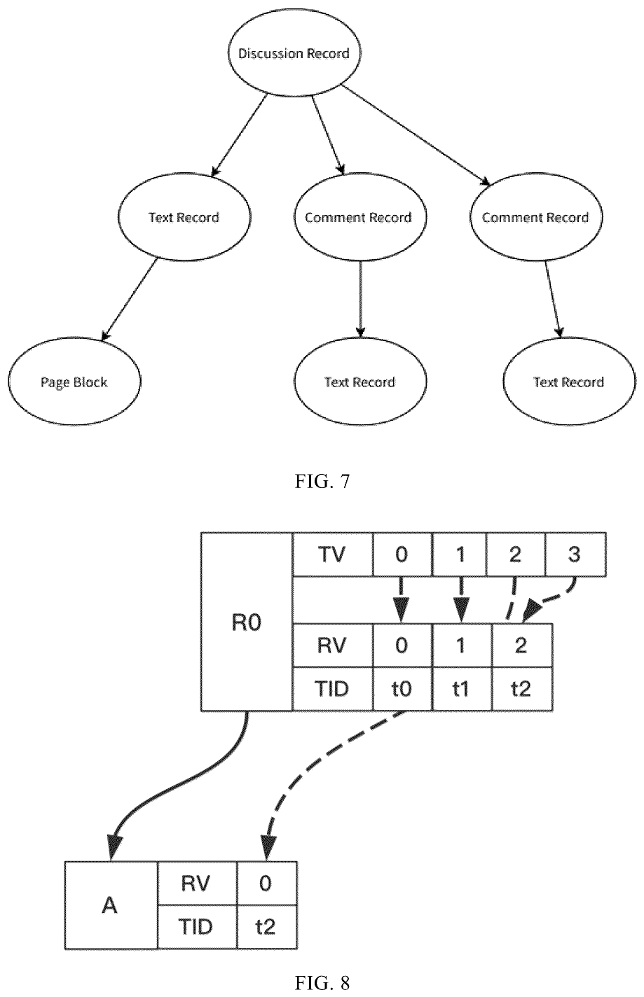

In some embodiments of the present disclosure, the first comment information in the discussion interface has an expanded state and an abridged state; when the first comment information is in the abridged state, abridged information and a first reply area of the first comment information is displayed; and when the comment information is in the expanded state, all information and a second reply area of the first comment information are displayed. In some embodiments, as shown in FIG. 4, the first comment information “It is a great idea” displayed in the middle of the discussion interface is in the abridged state. In the abridged state, if a length of the first comment information is less than a predetermined length, all of the first comment information will be displayed, otherwise only the frontmost content of the first comment information that equals to the predetermined length will be displayed. In the abridged state, the comment information may not be displayed but only the number of pieces of comment information will be displayed. When triggering the first comment information by clicking, etc., as shown in FIG. 7, the first comment information is displayed in the expanded state. At this time, all contents of the first comment information can be displayed, and a predetermined number of reply messages can be displayed. A reply area for replies is provided both in the abridged state and in expanded state, so as to facilitate users to reply quickly.

In order to better explain the method proposed by the embodiments of this disclosure, a specific embodiment is proposed below in conjunction with the accompanying drawings. In this embodiment, after performing wording on the first content “Content 2” in the content interface of the first document shown in FIG. 1, a toolbar shown in FIG. 1 is displayed above the first content. A post option in the toolbar that appears is clicked to display the comment publishing interface shown in FIG. 2. The input text is displayed in the upper part of the comment publishing interface; and the input picture is displayed in the lower part of the comment publishing interface. The content input in the comment publishing interface is used as the first comment information. Then the first comment information is published. As shown in FIG. 3, after the first comment information is published, the first comment information will be published simultaneously in the discussion interface. The first comment information in the content interface of the first document is kept in association and synchronization with the first comment information in the discussion interface, and the first comment information is shown in the discussion interface in the form of a post. When a user interacts with the first document within the first document or on the discussion interface, the interactive content (new posts, comments, followers) will be synchronized in real time between the content interface and the discussion interface. The state of the first comment information will also be synchronized in real time (if the first comment information is deleted on one side, it will also be deleted on the other side), and direct jumps and interactions can be made between the discussion interface and the content interface of the first document. As shown in FIG. 7, in the first document, after triggering “ . . . ” in the upper right corner of the comment display interface where the first comment information is located, the option “Open from discussion” is provided; and after triggering this option, the first comment information displayed in the discussion interface will be opened. As shown in FIG. 4, an identification of the first document (the “first document” after From in FIG. 4) is displayed in the first comment information in the discussion interface. By triggering the identification of the first document, the first comment information in the first document can be opened. By clicking the identification of the first document at the top, the corresponding first document can be opened and then the first content of the first comment information correspondingly generated can be located, and the first content will be highlighted for 2 seconds. In this embodiment, comments can be initiated after the wording operation is performed in the first document. Users of the first document may view the update of the first comment information within both the first document and the discussion interface, and make comments, subscription on the first comment information; the display in the first document and the discussion interface can be updated synchronously, and when operating the comment under the first comment, the display within both the first document and the discussion interface can be updated synchronously.

In some embodiments of this disclosure, the first comment information, the reply information and the first content are all stored as a record (Record), and the first comment information and reply information (i.e., a post) form a record RecordTree. As shown in FIG. 7, the first comment information Discussion Record is at the top, the first-level sub-nodes include content Text Record and reply information Comment Record in the first comment information; and the second-level sub-nodes include quoted first content Page Block and content in reply message Text Record.

A Record has associated data, the most core data of which is a record version (Record Version, RV), which records the change history of data of the Record. But Records are independent from each other. For changes of different Records on RecordTree, their timing and atomicity relationships need to be recorded. This is the responsibility of the tree version (TreeVersion, TV) and time identity (TID) in the associated data. A version relation graph (VRG, Version Relation Graph) is used to describe the logical data structure of RecordTree, that is, the spatiotemporal relationship between RV, TV and TID. Among them, the solid line represents the parent-child relationship of the Record, and the dotted line represents the mapping relationship between versions of TV and RV. As shown in FIG. 8, at the root node R0 in the record tree, when TV=0, RV=0, and TID=t0 for R0, R0 is created, and the content of R0 is assigned a value when TV=1 for R0. At this time, RV is 1, TID=t1, when TV=2, child node A is created for R0. At this time, the RV for A is 0, and its corresponding TID=t2, and then the state of R0 is recorded at this time, that is, the state when TV=3; at this time RV=2, corresponding TID=t2. Since R0 and A correspond to each other through TID=t2, it can be known that the state of RV=0 for A corresponds to the state of R0=2. RecordVersion reflects the history of the Record itself, and RecordTreeVersion reflects the history of the subtree.

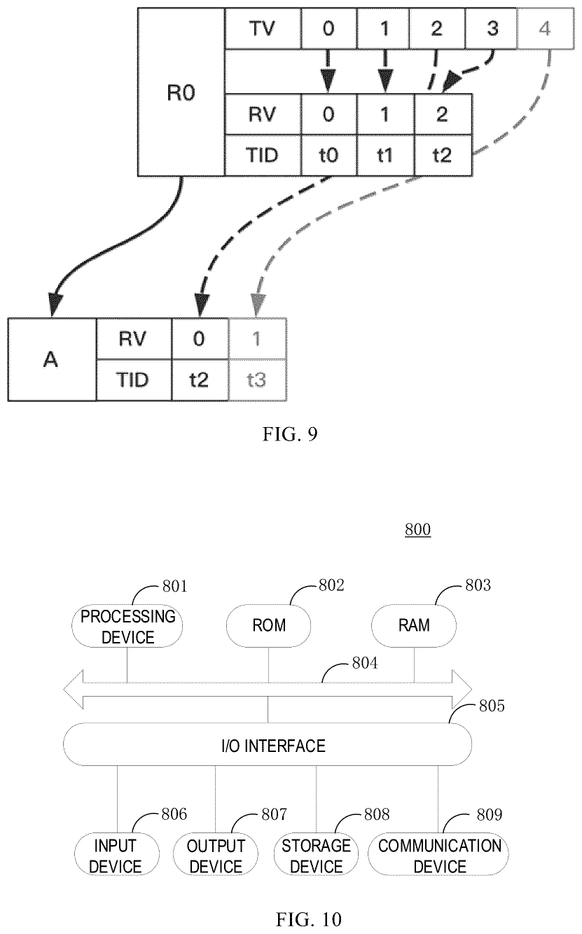

Therefore, when the Record generates a change operation, the RV of the Record will be increased by one, and the TV of the root node will also be increased by one. For example, as shown in FIG. 9, based on FIG. 8, if A is continuously be assigned a value to in the next step, the TV needs to be increased by one, and the RV of A also needs to be increased by one.

The embodiments of the present disclosure further provide an apparatus for information processing, including:
a creating unit configured to, in response to a first operation event on a first content in a content interface of a first document, create first comment information of the first content in the content interface;
a publishing unit configured to publish the first comment information to a discussion interface;
wherein the content interface and the discussion interface are different interfaces, and the discussion interface is configured to display information published by a current user and an associated user of the current user.

In some embodiments, at least one of the following is satisfied:
the first comment information in the content interface is kept in synchronization with the first comment information in the discussion interface;
associated information of the first comment information in the content interface is kept in synchronization with the associated information of the first comment information in the discussion interface; and
a state of the first comment information in the content interface is kept in synchronization with a state of the first comment information in the discussion interface.

In some embodiments, the associated information of the first comment information comprises at least one of: reply information for the first comment information, like information for the first comment information, or share information for the first comment information.

In some embodiments, the apparatus for information processing further includes:
a jumping unit configured to, in response to a triggering operation on a first control associated with the first comment information in the content interface, jump to the first comment information in the discussion interface; and/or,
a jumping unit configured to, in response to a triggering operation on a second control associated with the first comment information in the discussion interface, jump to the first comment information in the content interface.

In some embodiments, the first comment information in the content interface is displayed in a first predetermined format, the first comment information and at least one of the following are displayed in the first predetermined format: a publisher of the comment information, publication time of the comment information, a like identification of the comment information, the number of likes of the comment information, a reply identification of the comment information, the number of replies of the comment information, an share identification of the comment information, the number of shares of the comment information, a reply area.

In some embodiments, the first comment information in the discussion interface is displayed in a second predetermined format, the first comment information and at least one of the following are displayed in the second predetermined format: a publisher of the comment information, publication time of the comment information, a like identification of the comment information, the number of likes of the comment information, a reply identification of the comment information, the number of replies of the comment information, a share identification of the comment information, the number of shares of the comment information, a reply area, quoted first content, an identification of the first document.

In some embodiments, after the identification of the first document is triggered, one of the following is performed: opening the first document; opening the first document and locating to the first content; opening the first document, locating to the first content and highlighting the first content.

In some embodiments, if the content interface of the first document is displayed in full screen, the content interface and the discussion interface are in different display interfaces.

In some embodiments, if the content interface of the first document is not displayed in full screen and the content interface of the first document is not displayed in full screen, the content interface and the discussion interface are in different tab pages, the tab pages are pages independent from each other.

In some embodiments, in response to the first operation event on the first content in the content interface of the first document, creating the first comment information of the first content in the content interface comprises:
in response to a first operation on the first content, displaying a comment publishing interface; and in response to a second operation, creating the first comment information of the first content based on information input to the comment publishing interface.

In some embodiments, the comment publishing interface comprises at least one of: a quotation area, a text area and a picture area; the quotation area is configured to display part or all of the first content; the text area is configured to display a text input to the comment publishing interface; and the picture area is configured to display a picture input to the comment publishing interface.

In some embodiments, the method further comprises performing at least one of the following after creating the first comment information of the first content in the content interface: displaying a first identification at an associated position of the first content; and displaying the first content in a first style which is different from a second style when the first content does not have associated comment information.

In some embodiments, further comprise: a display unit configured to, in response to a third operation on the first content, display a comment display interface on a side of the first content, the first comment information being displayed on the comment display interface.

In some embodiments, at least one of the following is satisfied:
if the comment display interface is displayed, an input identification is focused on a reply area in the comment display interface; a third control is displayed on the comment display interface, the third control is configured to switch comment information displayed on the comment display interface after being triggered, and the comment information displayed on the comment display interface after being switched is comment information in the first document.

In some embodiments, at least one of the following is satisfied:
a fourth control is displayed on a display interface, and the discussion interface is displayed after the fourth control is triggered;
an information publishing area is displayed on the discussion interface, and the information publishing area is configured to publish information;
a fifth control is displayed in the discussion interface, the fifth control is configured to display an information publishing interface after being triggered, and the information publishing interface is configured to publish information on the discussion interface;
the discussion interface comprises a first sub-interface and a second sub-interface, the first sub-interface is configured to display all information published on the discussion interface, and the second sub-interface is configured to display information associated with the current user in the discussion interface.

In some embodiments, the first comment information in the discussion interface has an expanded state and an abridged state; if the first comment information is in the abridged state, abridged information and a first reply area of the first comment information is displayed; and if the comment information is in the expanded state, all information and a second reply area of the first comment information are displayed.

For the apparatus embodiments, since they basically correspond to the method embodiments, please refer to the description of the method embodiments for relevant information. The apparatus embodiments described above are only illustrative, and the modules described as separate modules may or may not be separate. Part or all of the modules may be selected according to actual needs to achieve the purpose of this embodiment solution. Persons of ordinary skill in the art can understand and implement the method without any creative effort.

Above, the method and apparatus of the present disclosure have been described based on the embodiments and application examples. In addition, the present disclosure further provides a terminal and a storage medium. The terminal and storage medium are described below.

Referring to FIG. 10, which is a schematic structural diagram of an electronic device 800 suitable for implementing the embodiments of the present disclosure. The electronic device in the embodiments of the present disclosure may include, but is not limited to, mobile terminals such as a mobile phone, a notebook computer, a digital broadcast receiver, a personal digital assistant (PDA), a PAD (tablet computer), a portable media player (PMP) and a vehicle-mounted terminal (for example, a vehicle-mounted navigation terminal), and fixed terminals such as a digital television (TV) and a desktop computer. The electronic device shown in FIG. 10 is merely an example and should not impose any restrictions on the functions and scope of use of the embodiments of the present application.

As shown in FIG. 10, the electronic device 800 may include a processing device (such as a central processing unit and a graphics processor) 801, which may execute various appropriate actions and processing according to a program stored in a read-only memory (ROM) 802 or a program loaded to a random access memory (RAM) 803 from a storage device 808. Various programs and data required during operation of the electronic device 800 are also stored in the RAM 803. The processing device 801, the ROM 802 and the RAM 803 are connected with one another via a bus 804. An input/output (I/O) interface 805 is also connected to the bus 804.

Generally, the following apparatuses may be connected to the I/O interface 805: an input device 806 including for example a touch screen, a touch pad, a keyboard, a mouse, a camera, a microphone, an accelerometer and a gyroscope; an output device 807 including for example a liquid crystal display (LCD), a speaker and a vibrator; a storage device 808 including for example a magnetic tape and a hard disk; and a communication device 809. The communication device 809 may allow wireless or wired communication between the electronic device 800 and other devices for data exchange. Although the figure shows the electronic device 800 having various devices, it should be understood that not all the devices shown are necessarily required to be implemented or provided. More or fewer devices may alternatively be implemented or provided.

In particular, according to the embodiments of the present disclosure, the process described above with reference to the flowcharts may be implemented as a computer software program. For example, an embodiment of the present disclosure provides a computer program product including a computer program carried on a non-transient computer-readable medium. The computer program includes a program code for executing the methods shown in the flowcharts. In such an embodiment, the computer program may be downloaded and installed from the network via the communication device 809, or installed from the storage device 808, or installed from the ROM 802. The computer program, when executed by the processing unit 801, causes the processing unit to execute the above functions defined in the methods according to the embodiments of the present disclosure.

It should be noted that the computer-readable medium according to the present disclosure may be a computer-readable signal medium or a computer-readable storage medium or any combination of the two. The computer-readable storage medium may be, for example, but is not limited to, an electrical, magnetic, optical, electromagnetic, infrared, or semiconductor system, apparatus, or device, or any combination thereof. More specific examples of the computer-readable storage medium include but are not limited to: an electrical connection with at least one wire, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program. The program may be used by or used in combination with an instruction execution system, apparatus, or device. However, in the present disclosure, the computer-readable signal medium may include a data signal propagated in baseband or as a part of a carrier wave, and computer-readable program code is carried therein. This propagated data signal may take many forms, including but not limited to electromagnetic signals, optical signals, or any suitable combination thereof. The computer-readable signal medium may also be any computer-readable medium other than the computer-readable storage medium. The computer-readable signal medium may send, propagate, or transmit the program used by or used in combination with the instruction execution system, apparatus, or device. The program code contained on the computer-readable medium may be transmitted by any suitable medium, including but not limited to, wire, optical cable, RF, etc., or any suitable combination thereof.

In some implementations, a client and server may communicate using any currently known or future developed network protocol such as HTTP (HyperText Transfer Protocol) and may interconnect with any form or medium of digital data communication (such as communication networks). Examples of communication networks include Local Area Networks (LANs), Wide Area Networks (WANs), the Internet (such as the Internet), and end-to-end networks (such as ad hoc end-to-end networks), as well as any network currently known or future developed.

The computer-readable medium may be included in the electronic device described above; or it may stand alone without being assembled into the electronic device.

The computer-readable medium carries one or more programs. When the one or more programs are executed by the electronic device, the electronic device is caused to perform the above-mentioned method of the present disclosure.

The computer program code for performing the operations of the present disclosure may be written in one or more programming languages or a combination thereof, which include but are not limited to object-oriented programming languages Java, Smalltalk, C++, and conventional procedural programming languages such as “C” or similar programming languages. The program codes may be executed completely on a user computer, partially on a user computer, as an independent package, partially on a user computer and partially on a remote computer, or completely on a remote computer or server. In cases involving a remote computer, the remote computer may be connected to a user computer through any type of network, including a local area network (LAN) or a wide area network (WAN), or may be connected to an external computer (for example, through the Internet by using an Internet service provider).

The flowcharts and the block diagrams in the drawings illustrate system architectures, functions and operations that may be implemented based on the system, method, and computer program product according to various embodiments of the present disclosure. In this regard, each block in the flowcharts or the block diagrams can represent one module, a program segment or a part of a code, and the module, the program segment or the part of the code includes at least one executable instruction for implementing specific logic functions. It should also be noted that, in some alternative implementations, the functions noted in the blocks may also occur in a sequence different from those illustrated in the drawings. For example, two consecutive blocks may be executed substantially in parallel, and may sometimes be executed in an opposite order, depending on the functions involved. It should also be noted that each block in the block diagrams and/or the flowcharts, and combinations of the blocks in the block diagrams and/or the flowcharts can be implemented in a dedicated hardware-based system that performs the specified functions or operations, or can be implemented by the combination of dedicated hardware and computer instructions.

The units involved in the embodiments described in this application may be implemented in software or hardware. Herein, the name of the unit/module does not constitute a limitation on the unit itself in some cases.

The functions described above herein may be at least partially performed by one or more hardware logic components. For example, non-restrictively, example types of hardware logic components that may be used include: a field programmable gate array (FPGA), an application-specific integrated circuit (ASIC), an application-specific standard parts (ASSP), a system-on-chip (SOC), a complex programmable logic device (CPLD), and the like.

In the context of the present disclosure, the machine-readable medium may be a tangible medium that may contain or store a program used by or used in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination thereof.

According to one or more embodiments of the present disclosure, a method of information processing is provided, including:
in response to a first operation event on a first content in a content interface of a first document, creating first comment information of the first content in the content interface, and publishing the first comment information to a discussion interface; wherein the content interface and the discussion interface are different interfaces, and the discussion interface is configured to display information published by a current user and an associated user of the current user.

According to one or more embodiments of the present disclosure, the method of information processing is provided that satisfies at least one of the following:
the first comment information in the content interface is kept in synchronization with the first comment information in the discussion interface;
associated information of the first comment information in the content interface is kept in synchronization with the associated information of the first comment information in the discussion interface; and
a state of the first comment information in the content interface is kept in synchronization with a state of the first comment information in the discussion interface.

According to one or more embodiments of the present disclosure, the method of information processing is provided, and the associated information of the first comment information comprises at least one of: reply information for the first comment information, like information for the first comment information, or share information for the first comment information.

According to one or more embodiments of the present disclosure, the method of information processing is provided, further comprising:
in response to a triggering operation on a first control associated with the first comment information in the content interface, jumping to the first comment information in the discussion interface; and/or,
in response to a triggering operation on a second control associated with the first comment information in the discussion interface, jumping to the first comment information in the content interface.

According to one or more embodiments of the present disclosure, a method of information processing is provided, the first comment information in the content interface is displayed in a first predetermined format, the first comment information and at least one of the following are displayed in the first predetermined format: a publisher of the comment information, publication time of the comment information, a like identification of the comment information, the number of likes of the comment information, a reply identification of the comment information, the number of replies of the comment information, an share identification of the comment information, the number of shares of the comment information, a reply area; and/or, the first comment information in the discussion interface is displayed in a second predetermined format, the first comment information and at least one of the following are displayed in the second predetermined format: a publisher of the comment information, publication time of the comment information, a like identification of the comment information, the number of likes of the comment information, a reply identification of the comment information, the number of replies of the comment information, a share identification of the comment information, the number of shares of the comment information, a reply area, quoted first content, an identification of the first document.

According to one or more embodiments of the present disclosure, the method of information processing is provided. After the identification of the first document is triggered, one of the following is performed:
opening the first document; opening the first document and locating to the first content; opening the first document, locating to the first content and highlighting the first content

According to one or more embodiments of the present disclosure, the method of information processing is provided. If the content interface of the first document is displayed in full screen, the content interface and the discussion interface are in different display interfaces; or,
if the content interface of the first document is not displayed in full screen and the content interface of the first document is not displayed in full screen, the content interface and the discussion interface are in different tab pages, the tab pages are pages independent from each other.

According to one or more embodiments of the present disclosure, the method of information processing is provided, in response to the first operation event on the first content in the content interface of the first document, creating the first comment information of the first content in the content interface comprises:
in response to a first operation on the first content, displaying a comment publishing interface; and in response to a second operation, creating the first comment information of the first content based on information input to the comment publishing interface.

According to one or more embodiments of the present disclosure, the method of information processing is provided, and the comment publishing interface comprises at least one of: a quotation area, a text area and a picture area;
the quotation area is configured to display part or all of the first content;
the text area is configured to display a text input to the comment publishing interface; and
the picture area is configured to display a picture input to the comment publishing interface.

According to one or more embodiments of the present disclosure, the method of information processing is provided, the method further comprises performing at least one of the following after creating the first comment information of the first content in the content interface:
displaying a first identification at an associated position of the first content; and
displaying the first content in a first style which is different from a second style if the first content does not have associated comment information.

According to one or more embodiments of the present disclosure, the method of information processing is provided, further comprising:
in response to a third operation on the first content, displaying a comment display interface on a side of the first content, the first comment information being displayed on the comment display interface.

According to one or more embodiments of the present disclosure, the method of information processing is provided that satisfies at least one of the following:
if the comment display interface is displayed, an input identification is focused on a reply area in the comment display interface;
a third control is displayed on the comment display interface, the third control is configured to switch comment information displayed on the comment display interface after being triggered, and the comment information displayed on the comment display interface after being switched is comment information in the first document.

According to one or more embodiments of the present disclosure, the method of information processing is provided that satisfies at least one of the following:
a fourth control is displayed on a display interface, and the discussion interface is displayed after the fourth control is triggered;
an information publishing area is displayed on the discussion interface, and the information publishing area is configured to publish information;
a fifth control is displayed in the discussion interface, the fifth control is configured to display an information publishing interface after being triggered, and the information publishing interface is configured to publish information on the discussion interface;
the discussion interface comprises a first sub-interface and a second sub-interface, the first sub-interface is configured to display all information published on the discussion interface, and the second sub-interface is configured to display information associated with the current user in the discussion interface.

According to one or more embodiments of the present disclosure, the method of information processing is provided, and the first comment information in the discussion interface has an expanded state and an abridged state;
if the first comment information is in the abridged state, abridged information and a first reply area of the first comment information is displayed; and
if the comment information is in the expanded state, all information and a second reply area of the first comment information are displayed.

According to one or more embodiments of the present disclosure, an apparatus for information processing is provided, including:
a creating unit configured to, in response to a first operation event on a first content in a content interface of a first document, create first comment information of the first content in the content interface;
a publishing unit configured to publish the first comment information to a discussion interface;
wherein the content interface and the discussion interface are different interfaces, and the discussion interface is configured to display information published by a current user and an associated user of the current user.

According to one or more embodiments of the present disclosure, a terminal is provided, including: at least one memory and at least one processor;
wherein the at least one memory is configured to store program code, and the at least one processor is configured to call the program code stored in the at least one memory to perform any of the methods described above.

According to one or more embodiments of the present disclosure, a computer readable storage medium is provided. The computer readable storage medium is used to store program code, which, when run by a processor, causes the processor to perform the above-mentioned steps.

The above description is only for the preferred embodiments of the present disclosure and an explanation of the technical principles used. Those skilled in the art should understand that the scope involved in the present disclosure is not limited to technical solutions formed by specific combinations of the aforementioned technical features, and should also cover other technical solutions formed by any combinations of the aforementioned technical features or their equivalent features without departing from the disclosed concept. For example, a technical solution is formed by replacing the above features with (but not limited to) technical features with similar functions disclosed in this disclosure.

Furthermore, although operations are depicted in a specific order, this should not be understood as requiring that these operations be performed in the specific order shown or performed in a sequential order. In certain environments, multitasking and parallel processing may be advantageous. Likewise, although several specific implementation details are included in the above discussion, these should not be interpreted as limitations on the scope of this disclosure. Certain features described in the context of individual embodiments may also be combined to be implemented in a single embodiment. On the contrary, various features described in the context of a single embodiment may also be implemented separately or in any suitable sub combination in multiple embodiments.

Although the present subject matter has been described in language specific to structural features and/or methodological logical actions, it should be understood that the subject matter defined in the attached claims may not necessarily be limited to the specific features or acts described above. On the contrary, the specific features and actions described above are only example forms of implementing the claims.

1. A method of information processing, comprising:
in response to a first operation event on a first content in a content interface of a first document, creating first comment information of the first content in the content interface, and publishing the first comment information to a discussion interface;
wherein the content interface and the discussion interface are different interfaces, and the discussion interface is configured to display information published by a current user and an associated user of the current user.

2. The method of claim 1, wherein at least one of the following is satisfied:
the first comment information in the content interface is kept in synchronization with the first comment information in the discussion interface;
associated information of the first comment information in the content interface is kept in synchronization with the associated information of the first comment information in the discussion interface; and
a state of the first comment information in the content interface is kept in synchronization with a state of the first comment information in the discussion interface.

3. The method of claim 2, wherein the associated information of the first comment information comprises at least one of: reply information for the first comment information, like information for the first comment information, or share information for the first comment information.

4. The method of claim 1, further comprising:
in response to a triggering operation on a first control associated with the first comment information in the content interface, jumping to the first comment information in the discussion interface; and/or,
in response to a triggering operation on a second control associated with the first comment information in the discussion interface, jumping to the first comment information in the content interface.

5. The method of claim 1, wherein,
the first comment information in the content interface is displayed in a first predetermined format, the first comment information and at least one of the following are displayed in the first predetermined format: a publisher of the comment information, publication time of the comment information, a like identification of the comment information, the number of likes of the comment information, a reply identification of the comment information, the number of replies of the comment information, an share identification of the comment information, the number of shares of the comment information, a reply area; and/or,
the first comment information in the discussion interface is displayed in a second predetermined format, the first comment information and at least one of the following are displayed in the second predetermined format: a publisher of the comment information, publication time of the comment information, a like identification of the comment information, the number of likes of the comment information, a reply identification of the comment information, the number of replies of the comment information, a share identification of the comment information, the number of shares of the comment information, a reply area, quoted first content, an identification of the first document.

6. The method of claim 5, wherein after the identification of the first document is triggered, one of the following is performed:
opening the first document; opening the first document and locating to the first content; opening the first document, locating to the first content and highlighting the first content.

7. The method of claim 1, wherein,
if the content interface of the first document is displayed in full screen, the content interface and the discussion interface are in different display interfaces; or,
if the content interface of the first document is not displayed in full screen and the content discussion interface of the first document is not displayed in full screen, the content interface and the discussion interface are in different tab pages, the tab pages are pages independent from each other.

8. The method of claim 1, wherein in response to the first operation event on the first content in the content interface of the first document, creating the first comment information of the first content in the content interface comprises:
in response to a first operation on the first content, displaying a comment publishing interface; and
in response to a second operation, creating the first comment information of the first content based on information input to the comment publishing interface.

9. The method of claim 8, wherein,
the comment publishing interface comprises at least one of: a quotation area, a text area and a picture area;
the quotation area is configured to display part or all of the first content;
the text area is configured to display a text input to the comment publishing interface; and
the picture area is configured to display a picture input to the comment publishing interface.

10. The method of claim 1, wherein the method further comprises performing at least one of the following after creating the first comment information of the first content in the content interface:
displaying a first identification at an associated position of the first content; and
displaying the first content in a first style which is different from a second style if the first content does not have associated comment information.

11. The method of claims 1, further comprising:
in response to a third operation on the first content, displaying a comment display interface on a side of the first content, the first comment information being displayed on the comment display interface.

12. The method of claim 11, wherein at least one of the following is satisfied:
if the comment display interface is displayed, an input identification is focused on a reply area in the comment display interface;
a third control is displayed on the comment display interface, the third control is configured to switch comment information displayed on the comment display interface after being triggered, and the comment information displayed on the comment display interface after being switched is comment information in the first document.

13. The method of claim 1, wherein at least one of the following is satisfied:
a fourth control is displayed on a display interface, and the discussion interface is displayed after the fourth control is triggered;
an information publishing area is displayed on the discussion interface, and the information publishing area is configured to publish information;
a fifth control is displayed in the discussion interface, the fifth control is configured to display an information publishing interface after being triggered, and the information publishing interface is configured to publish information on the discussion interface;
the discussion interface comprises a first sub-interface and a second sub-interface, the first sub-interface is configured to display all information published on the discussion interface, and the second sub-interface is configured to display information associated with the current user in the discussion interface.

14. The method of claim 1, wherein,
the first comment information in the discussion interface has an expanded state and an abridged state;
if the first comment information is in the abridged state, abridged information and a first reply area of the first comment information is displayed; and
if the comment information is in the expanded state, all information and a second reply area of the first comment information are displayed.

15. (canceled)

16. (canceled)

17. (canceled)

18. A terminal, comprising:
at least one memory and at least one processor;
wherein the at least one memory is configured to store program code, and the at least one processor is configured to call the program code stored in the at least one memory to perform acts of information processing, the acts comprises:
in response to a first operation event on a first content in a content interface of a first document, creating first comment information of the first content in the content interface, and publishing the first comment information to a discussion interface;
wherein the content interface and the discussion interface are different interfaces, and the discussion interface is configured to display information published by a current user and an associated user of the current user.

19. The terminal of claim 18, wherein at least one of the following is satisfied:
the first comment information in the content interface is kept in synchronization with the first comment information in the discussion interface;
associated information of the first comment information in the content interface is kept in synchronization with the associated information of the first comment information in the discussion interface; and
a state of the first comment information in the content interface is kept in synchronization with a state of the first comment information in the discussion interface.

20. The terminal of claim 19, wherein the associated information of the first comment information comprises at least one of: reply information for the first comment information, like information for the first comment information, or share information for the first comment information.

21. The terminal of claim 18, further comprising:
in response to a triggering operation on a first control associated with the first comment information in the content interface, jumping to the first comment information in the discussion interface; and/or,
in response to a triggering operation on a second control associated with the first comment information in the discussion interface, jumping to the first comment information in the content interface.

22. The terminal of claim 18, wherein,
the first comment information in the content interface is displayed in a first predetermined format, the first comment information and at least one of the following are displayed in the first predetermined format: a publisher of the comment information, publication time of the comment information, a like identification of the comment information, the number of likes of the comment information, a reply identification of the comment information, the number of replies of the comment information, an share identification of the comment information, the number of shares of the comment information, a reply area; and/or,
the first comment information in the discussion interface is displayed in a second predetermined format, the first comment information and at least one of the following are displayed in the second predetermined format: a publisher of the comment information, publication time of the comment information, a like identification of the comment information, the number of likes of the comment information, a reply identification of the comment information, the number of replies of the comment information, a share identification of the comment information, the number of shares of the comment information, a reply area, quoted first content, an identification of the first document.

23. A non-transitory computer readable storage medium for storing program code, which, when run by a processor, causes the processor to perform acts of information processing, the acts comprises:
in response to a first operation event on a first content in a content interface of a first document, creating first comment information of the first content in the content interface, and publishing the first comment information to a discussion interface;
wherein the content interface and the discussion interface are different interfaces, and the discussion interface is configured to display information published by a current user and an associated user of the current user.
